(19) United States
(12) Patent Application Publication
(10) Pub. No.: US 2011/0176669 A1
(43) Pub. Date: Jul. 21, 2011

(54) POST-DIAL DELAY DURING RANDOMIZATION

(76) Inventor: Karl Seelig, Beverly Hills, CA (US)

(21) Appl. No.: 13/007,566

(22) Filed: Jan. 14, 2011

Related U.S. Application Data
(60) Provisional application No. 61/295,601, filed on Jan. 15, 2010.

(51) Int. Cl. H04M 3/42

(52) U.S. Cl. 379/207.16

(57) ABSTRACT

Determining a customized delay value for setting a post-dial delay after a call has initiated is disclosed. In one embodiment, a randomized delay may be provided. In another embodiment, a set delay may be provided. Playback of a ringback tone may be delayed for at least the randomized or set delay period and/or the length of ring back tone period may be increased by the randomized time period.

### BACKGROUND OF THE INVENTION

The present disclosure relates in general to certain new and useful improvements in telecommunication systems including, without limitation, systems which may use the Internet, Internet protocol, Voice over Internet Protocol (“VoIP”), switching systems, intelligent networks, CAMEL protocol, short message systems, any other means of transmitting voice, video, data, multimedia content, or a subset of the preceding examples. A ‘subset’ as used herein can comprise elements of a given set that include the same elements as the given set or a smaller number of elements. The present disclosure more particularly relates to telecommunication systems which may make a message(s) (e.g., content including, but not limited, to audio, visual, multimedia, text, or a subset of the preceding examples) available to a caller.

In a telecommunications system, a “caller” may be, but is not limited to, any device, person, group of persons, software, or a subset of the preceding examples that initiates a call in the telecommunications system. During a typical call, the caller hears an audible ringback tone before the call is connected to a called party. The audible ringback tone notifies the calling party that the called party is being rung. For example, the ringback tone may be an audible ringing sound composed of several pulse tones.

Telecommunications carriers now provide personalized ringback tones (“PRBTs”) that replace the standard ringback tone with customized audible sounds. PRBTs have been popularized in Asian and European markets. Telecommunications carriers in North America have also introduced services that provide PRBTs.

Telecommunications carriers now provide personalized ringback tones (“PRBTs”) that replace the standard ringback tone with customized audible sounds. PRBTs have been popularized in Asian and European markets. Telecommunications carriers in North America have also introduced services that provide PRBTs.

In most telecommunications systems, after a caller “initiates a call” (e.g., transmits information about the destination including for example, but not exclusively, numbers, letters, speed dial information, telephone numbers, e-mail addresses, SKYPE addresses, etc.), a period of time known as a “post-dial delay” elapses after the call has been initiated or dialed before a ringback signal or ringback tone may be audible, visible, or audible and visible to the caller.

A ringback signal or ringback tone may be initiated by the telephone switching station, media player, computing device (e.g., computer, server, etc.), VoIP server, network, telephone (e.g., telephone, cellular phone, smart phone, device in communication with the Internet, computing device with speaker and microphone, standard telephone, or a subset of the preceding examples, etc.), or a subset of the preceding examples. As soon as the called person, device, or network feature answers the call, the ringback signal or ringback tone may stop.

Further, telecommunications systems may be enhanced with additional devices as for example, but not limited to, call waiting, call forwarding, three way calling, conference calling, call termination out of virtual realities, call termination into virtual realities, changing communication protocols, routing methods, or a subset of the preceding examples, etc. In each case, a ringback signal or ringback tone may exist.

Within a particular telecommunications system, the post-dial delay may be steady in duration before the ringback signal or tone begins to play. For example, the duration of the postdial delay may not fluctuate with great variability between separate calls. Callers are accustomed to experiencing the post-dial delay before hearing the ringback tone. As a result, callers may become adept at timing the length of the post-dial delay to avoid listening during the post-dial delay and ringback tone. Therefore, callers may mentally “tune out” any audible sound (or remove the receiver or headset from their ears) during the post-dial delay before the call is connected with the called party. Consequently, a solution is needed for adjusting the post-dial delay between separate calls to increase the effectiveness of ringback tone playback. This new concept of randomization herein disclosed is greatly needed; for example, to increase the efficiency of ringback tone advertising, and increase the potential profitability of said advertising. It has been observed that after initiating a telephone call, humans let a period of approximately five seconds elapse before actively listening to the telephone. They do this because they know that the other party will not answer the call until this period has elapsed. If one would increase the time period by a standard factor in order to allow for greater content, humans would quickly adjust to this longer time period, and would begin actively listening later than this five-second period. Thus, computing and/or randomizing this time period for the delay will greatly increase the efficiency of the presented message, as humans cannot adjust to a random and/or computed delay.

### SUMMARY OF THE INVENTION

Embodiments may receive a call. Playback of a ringback tone may be delayed using a randomized or set delay. Playback of the ringback tone may begin after or during the randomized or set delay. Next, the call is connected.

### BRIEF DESCRIPTION OF THE DRAWINGS

The present invention is illustrated by way of example and not limitation in the figures of the accompanying drawings in which like references indicate similar elements. It should be noted that references to “an” or “one” embodiment in this disclosure are not necessarily to the same embodiment, and such references mean “at least one.”

FIG. 1 is a diagram illustrating one embodiment of a signaling flow chart 100 for connecting a call.

FIG. 2A is a diagram of one embodiment of a system 200 for ringback tone replacement.

FIG. 2B is a diagram of one embodiment of a system 250 for ringback tone replacement and connecting a caller to a called party.

FIG. 3 is a diagram of an embodiment of an apparatus 300 for introducing a customized delay in a telecommunications system.

FIG. 4 is a diagram of one embodiment of a timing chart 400 for ringback tone replacement as known in the prior art.

FIG. 5A is a diagram of an embodiment of a timing chart 500 for introducing a randomized delay to delay ringback tone playback.

FIG. 5B is a diagram of one embodiment of a timing chart 550 for introducing a set delay for ringback tone playback.

FIG. 6 is a flowchart of one embodiment of a process 600 for determining a randomized or customized delay to delay ringback tone playback.

FIG. 7 is a flowchart of one embodiment of a process 700 for determining a delay during the ringback tone and/or post-dial delay.

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims. It will be apparent to one of ordinary skill in the art that the embodiments may be practiced without some of these specific details. In other instances, certain structures and devices are omitted or simplified to avoid obscuring the details of the various embodiments.

In telecommunications systems, a delay that may occur after a call is initiated, but before the occurrence of a ringback signal or ringback tone, is called a “post-dial delay.” The post-dial delay may be inherent in the telecommunication system design, be instituted on purpose, or a subset of the preceding examples. Although this time period may be short, perhaps no more than four to six seconds, depending upon the particular telephone, network design, or a subset of the preceding examples, this may be an unused time period. Callers familiar with telephone systems may have become accustomed to this time delay, and therefore this delay may be tolerated and may be even expected. Therefore, the audio, video, multimedia presentations, or a subset of the preceding examples may be played during the post-dial delay (called a “post dial delay tone”) as a ringback tone.

Messages may be made available to a caller as a ringback tone (e.g., an audio, video, multimedia message, or a subset of the preceding examples that is played instead of the ringback signal) during the post-dial delay. The message content may be delivered, acquired from search engines from local sources such as local networks, remote sources such as social networks, servers, databases, websites, local networks, or a subset of the preceding examples.

### Signaling Flow Chart for Connecting a Call

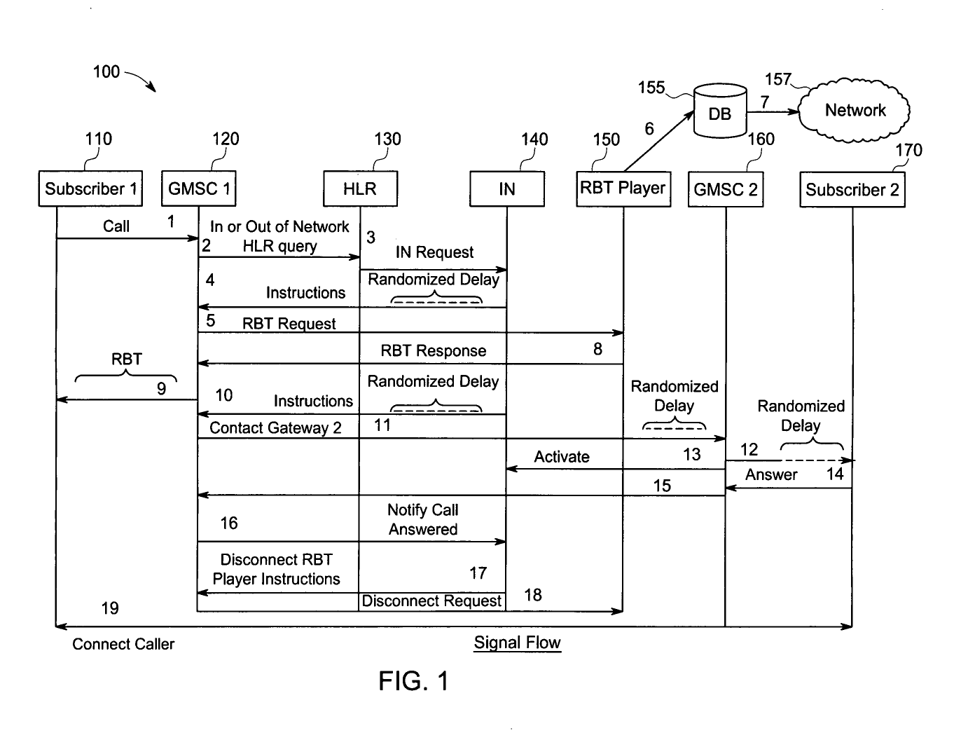

FIG. 1 is a diagram illustrating one embodiment of a signaling flow chart 100 for connecting a call. A call is received (1) by gateway mobile switching center (GMSC) 120 from a subscriber 110 (i.e., caller). GMSC 120 then submits a query (2) to a home location register (HLR) 130. HLR 130 processes the query and determines whether the called party is within the subscriber's 110 network. HLR 130 submits a request (3) to Intelligent Network 130. IN 130 processes the request and transmits instructions (4). As described herein, the instructions transmitted by IN 130 may include commands for a recipient to perform certain operations or may include commands that instruct the recipient to delegate operations to be performed by other recipients. For example, a recipient may be a GMSC or a RBT Player. The GMSC or RBT player may then directly perform the instructions from IN 130 or be tasked to delegate operations to be performed by another recipient in the network.

In one embodiment, the instructions include a randomized delay. The randomized delay may be determined using a mathematical formula or algorithmically generated. For example, a pseudorandom number generator may be used to generate a randomized value for the delay. The randomized delay may be used to delay a request by GMSC 120. In an alternate embodiment, a set delay having a predetermined value may be used instead of the randomized delay. The predetermined value may be set according to a predefined system setting or parameter and is not inherent to the telecommunications system. GMSC 120 transmits a request (5) to RBT player 150.

In one embodiment, RBT player 150 queries (6) DB 155 for ringback tone data. Ringback tone data in DB 155 may be used for ringback tone replacement for personalized ringback tones. DB 155 may be connected to network 157 and perform a search (7) in network 157 for data in various data sources including, but not limited to, social networking web sites (e.g., FACEBOOK, MYSPACE, LINKEDIN, TWITTER, etc.), Really Simple Syndication (RSS) feeds, blogs (e.g., BLOGGER, LIVEJOURNAL, etc.), instant messaging, contact databases, web sites or other data sources. For example, the data in network 157 may include status updates in social networking websites of the called party. The data retrieved data from outside data sources may be used for ringback tone replacement that is presented to the caller as a personalized ringback tone. In one embodiment, RBT player 150 performs text to speech conversion of the data retrieved from outside data sources in network 157.

RBT player 150 transmits a response (8) to GMSC 120. The response may include ringback tone data retrieved from DB 155 or outside data sources in network 157. GMSC 120 then transmits a ringback tone (9) to subscriber 110. The ringback tone may be a personalized ringback tone based on data from DB 155 or data retrieved from data sources in network 157. In one embodiment, GMSC 120 may perform conversion of the data into an audible sound presentation (i.e., text to speech conversion) as a personalized ringback tone. In one embodiment, playback of the ringback tone sent to subscriber 110 may be delayed by a period defined by the randomized delay or the set delay as mentioned above.

IN 140 may transmit a set of instructions (10) including a randomized delay. The randomized delay may be used in a flexible manner. For example, the randomized delay may be used to delay playback of the ringback tone or to increase the ring back tone period by increasing the post dial delay period. In another embodiment, the randomized delay may be used to delay connection of the caller with the called party. Yet in another embodiment, the randomized delay may be used to delay the ringing of the called party's terminal. In an alternate embodiment, a set delay having a predetermined value may be used instead of the randomized delay. The predetermined value may be set according to a predefined system setting or parameter and is not inherent to the telecommunications system. GMSC 120 may contact GMSC 160 and include the randomized delay (11). GMSC 160 signals (12) to subscriber 170 (i.e., the called party). The randomized delay may be used to delay GMSC from contacting subscriber 170 until the randomized delay has elapsed. Again, in an alternate embodiment, a set delay may be used instead of the randomized delay.

Subscriber 170 may signal an answer (14) to GMSC 160 and GMSC 160 signals (15) GMSC 120 that subscriber 170 has answered. GMSC 120 notifies (16) IN 140 that the call has been answered. IN 140 transmits (17) instructions to GMSC 120 to disconnect the RBT player and terminate playback of the ringback tone that is playing. GMSC 120 transmits (18) a disconnect request to RBT player 150 to stop playback of the ringback tone. Subscriber 110 is then connected (19) to subscriber 170.

### System for Introducing a Delay

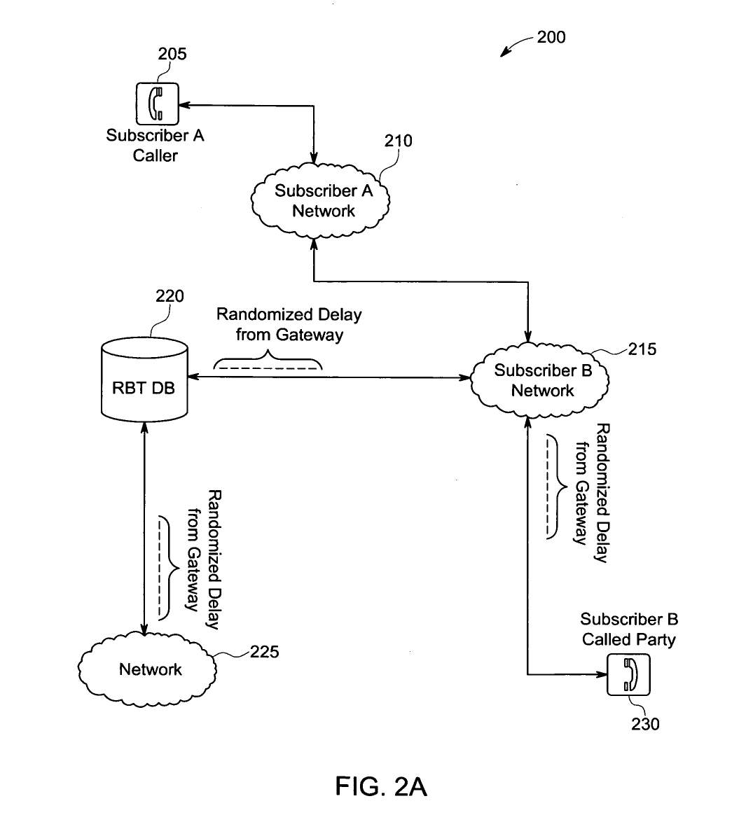

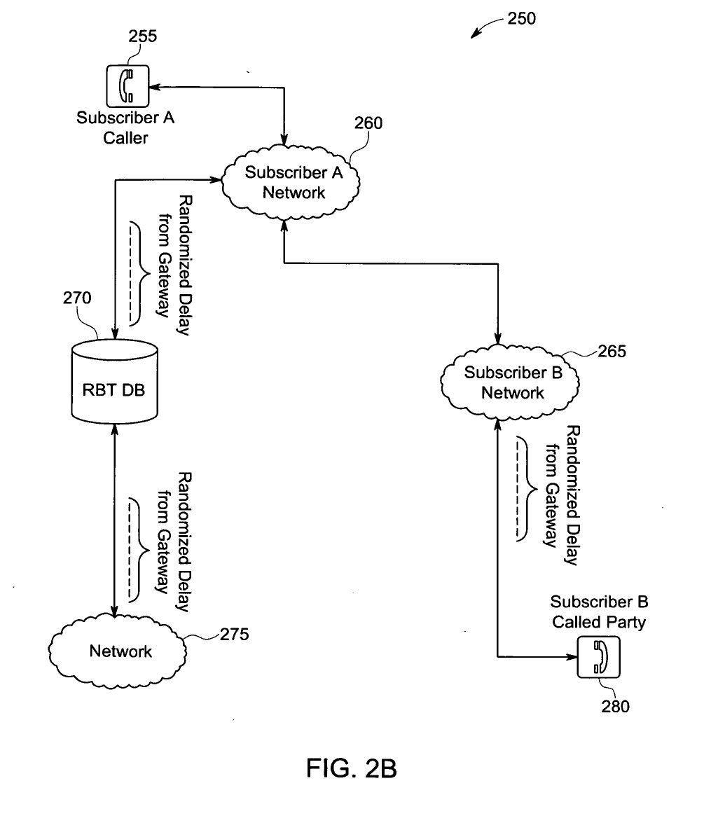

FIG. 2A is a diagram of one embodiment of a system 200 for ringback tone replacement and connecting a caller to a called party. Subscriber A 205 is a member of Subscriber A network 210. When Subscriber A 205 dials a number to make a call, the call is received by Subscriber A network 210. Based on the number of a called party, the call is then routed to the called party's network. The call is routed to Subscriber B network 215.

In one embodiment, ringback tone database 220 is connected with Subscriber B network 215. RBT DB 220 may also be connected to network 225 that includes outside data sources. For example, network 225 may include data sources such as, but not limited to, social networking websites, blogs, RSS feeds, contact databases, instant messaging or other data sources found on the Internet. For ringback tone replacement, RBT DB 220 may retrieve data related to the called party (e.g., Subscriber B 230) from social networking websites and other data sources in network 225. In one embodiment, the data for ringback tone replacement may include status updates of the called party. The data may undergo a text to speech conversation and be presented as a personalized ringback tone to a subscriber. Further, RBT DB 220 may store ringback tone data in a storage medium such as a mass storage device, or on a similar machine-readable medium.

A randomized delay may be computed and introduced in the system by a gateway or GMSC in the network 215 of Subscriber B. The randomized delay may be computed using a mathematical formula or algorithmically generated. In another embodiment, the system may use a set delay that is predetermined instead of the randomized delay. The set delay is not a delay that is inherent to the system and may be set according to a system parameter or setting or may be based on the requirements of a service provider. In one embodiment, the randomized delay may be introduced before sending a request to RBT DB 220. Moreover, the randomized delay may be introduced before retrieving data from outside sources in network 225. In another embodiment, a randomized delay may be computed by a gateway or GMSC in the network 215 of Subscriber B. The randomized delay by then be introduced in the system before signaling subscriber B (i.e., the called party).

FIG. 2B is a diagram of one embodiment of a system 250 for ringback tone replacement and connecting a caller to a called party. Subscriber A 260 is a member of Subscriber A network 210. After Subscriber A 260 dials a number to make a call, the call is received by Subscriber A network 260. Based on the number of a called party, the call is routed to the called party's network. For example, the call is routed to Subscriber B network 265. In one embodiment, ringback tone database 270 is connected with Subscriber A network 260. For ringback tone replacement, ringback tone database 270 may retrieve data related to the called party (e.g., Subscriber B 280) from social networks, instant messaging, RSS feeds, contact databases and other data sources in network 275. In one embodiment, the data for ringback tone replacement may include status updates of the called party. The data for be converted from text to speech for presentation as a personalized ringback tone. Moreover, RBT DB 270 may store ringback tone data in a storage medium such as a mass storage device, or on a similar machine readable medium.

In one embodiment, a randomized delay may be computed and introduced in the system by a gateway or GMSC in the network 260 of Subscriber A. The randomized delay maybe computed using a mathematical formula or algorithmically generated. In another embodiment, the system may use a set delay that is predetermined instead of the randomized delay. The set delay is not a delay that in inherent in the system but may be set according to a system parameter or setting and may be based on the requirements of a service provider. The randomized delay may be introduced before sending a request to RBT DB 270. Moreover, the randomized delay may be introduced before retrieving data from outside sources in network 275. In another embodiment, a randomized delay may be computed by a gateway or GMSC in the network 265 of Subscriber B. The randomized delay by then be introduced in the system before signaling subscriber B (i.e., the called party), which may increase the ringback tone period if the ring back tone is started in the post dial delay period.

### Apparatus for Computing a Customized Delay

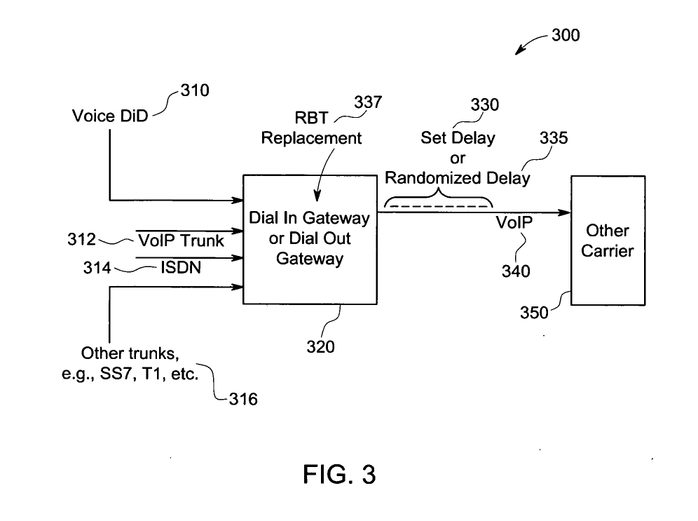

FIG. 3 is a diagram of an embodiment of an apparatus 300 for introducing a customized delay in a telecommunication system. In one embodiment, a call is received by dial in gateway 320. In another embodiment, the call is routed to a dial out gateway instead as illustrated in the alternative in FIG. 3. For purposes of clarity and brevity, the following description is directed to a dial in gateway but may also be applied for a dial out gateway as well. Dial in gateway 320 may receive a call from several types of originating trunks. For example, a call may be received by direct inward dialing from voice DID 310. In other embodiments, the call may be from received from a Voice over Internet Protocol (VoIP) trunk 312, an integrated services digital network (ISDN) trunk 314 or other types of trunks 316 such as Signaling System 7 (SS7), T1 (i.e., Digital Signal 1), etc. The call may be in the form of a public switched telephone network (PSTN) signal or as Internet Protocol (IP) packets. Dial in gateway 320 may transcode the call from a PSTN signal to IP packets or vice versa. In this manner, the call may be routed between disparate network topologies or subscriber networks with different or incompatible communication protocols.

In one embodiment, dial in gateway 320 computes a randomized delay 335. Dial in gateway 320 may include a processor for executing operations related to computing the randomized delay and/or a storage device that contains the executable instructions that comprise the process for determining the randomized delay. Further, dial in gateway 320 may include a communication interface to receive and route calls. Dial in gateway 320 may signal other carrier 350 to route the call. The randomized delay, as described before, may be determined by a mathematical formula or be algorithmically generated. In an alternate embodiment, dial in gateway 320 may use a set delay 330 that is a predetermined value and is not inherent to the system. For example, set delay 330 may be a value that is stored as a system parameter or setting or based on the requirements of a service provider. By using randomized delay 130 or set delay 330, dial in gateway 320 may provide customized delay times between a first phone call and any number of subsequent phone calls. For example, the delay before playback of the personalized ringback tone may vary between a first call and each subsequent call received by dial in gateway 320. The use of customized delay times allows for greater flexibility with controlling the timing of playback of personalized ringback tones and with timing the connection of a caller to a called party. Therefore, the apparatus illustrated in FIG. 3 may control the timing of a call in a more nuanced manner to meet the requirements of a service provider. In one embodiment, the call is routed as a VoIP call 340 to other carrier 350 after set delay 330 or randomized delay 335 has elapsed.

As illustrated in FIG. 3, dial in gateway 120 may provide a personalized ringback tone by performing ringback tone replacement. Personalized ringback tones are audible messages and sounds that replace standard ringback tones played to calling party prior to call establishment with the called party. A typical ringback tone may be a series of audible beeps to indicate that the called party is being rung. Personalized ringback tones may include music, a message, sound effects, or greetings. In one embodiment, the personalized ringback tone may include a message indicating the activity or status of the called party. The activity or status of the called party may be retrieved from a data source such as, but is not limited to, a social networking site (e.g., FACEBOOK, LINKEDIN, MYSPACE, TWITTER), instant messaging, profile server, RSS feed, contact database, website or other data source. In this manner, the calling party may be informed about the called party before the call is answered by the called party.

### Timing Charts for Ringback Tone Replacement

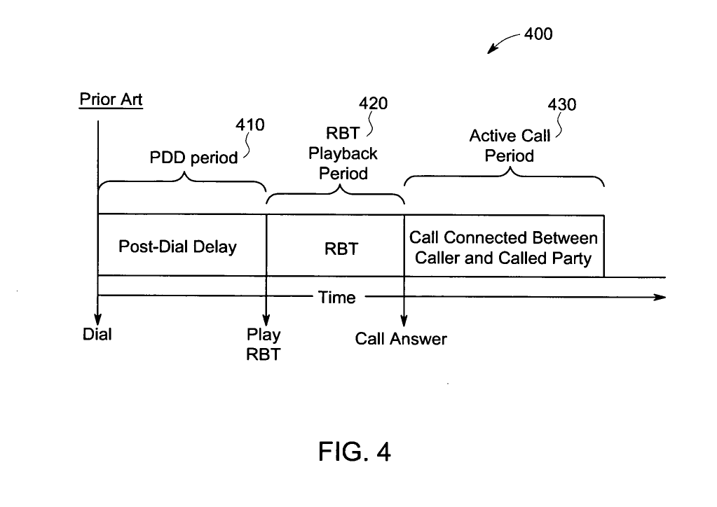

FIG. 4 is a diagram of one embodiment of a timing chart 400 for ringback tone replacement as known in the prior art. After a call is dialed, a post-dial delay period 410 elapses before playback of a ringback tone commences. The post-dial delay in FIG. 4 is inherent to the system and is not adjustable. The ringback tone continues to be played in RBT playback period 420 until the call is answered by the called party. Once the called party has answered, ringback tone playback is terminated. An active call period 430 commences after the call is connected between the caller and called party.

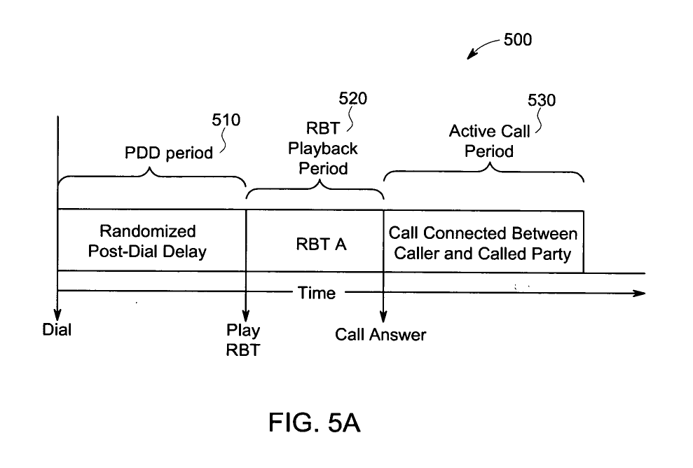

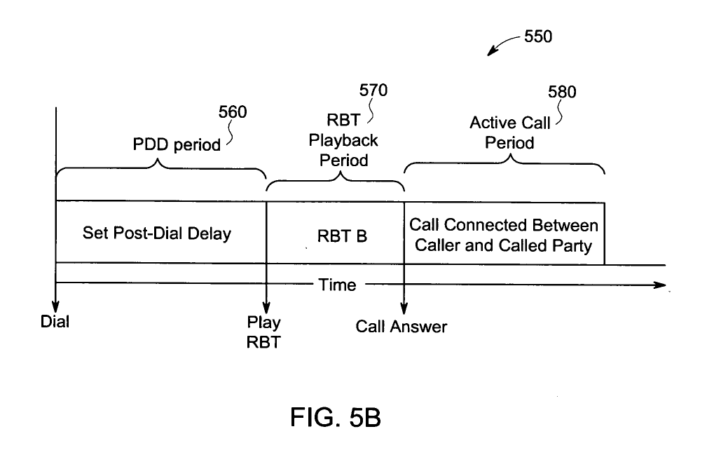

FIG. 5A is a diagram of an embodiment of a timing chart 500 for introducing a randomized delay to delay ringback tone playback. In one embodiment, after a call is dialed, a post-dial delay period 510 is set to a randomized value. As described previously, the randomized value may be determined by a mathematical formula or algorithmically generated. Moreover, the randomized value varies between calls. The randomized value is determined and ringback tone playback is delayed for at least the randomized value. Ringback tone playback period 520 commences after a ringback tone begins playback. After the call is answered, active call period 530 begins and playback of the ringback tone is terminated.

FIG. 5B is a diagram of one embodiment of a timing chart 550 for introducing a set delay for ringback tone playback. In one embodiment, after a call is dialed, a post-dial delay period 560 is set to a set value that is predetermined. For example, the set value may be determined according to a predefined system parameter or setting. The set value is not inherent to the system and may be determined according to the requirements of a service provider. Ringback tone playback is delayed for at least the set value. Ringback tone playback period 570 commences after a ringback tone begins playback. Next, when the call is answered, active call period 580 begins and playback of the ringback tone is terminated.

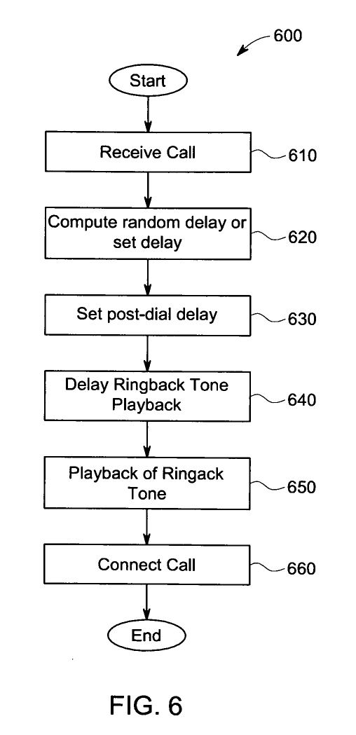

FIG. 6 is a flow chart of one embodiment of a process 600 for determining a randomized or customized delay to delay ringback tone playback. At block 610, a call is received. At block 620, a random delay or a set delay is computed. Next, a post-dial delay is set to at least the random delay or the set delay at block 630. At block 640, ringback tone playback is delayed by the random delay or the set delay. At block 650, playback of the ringback tone commences if the ringback tone has not started to play at a prior point block 610-640. The call is connected at block 660.

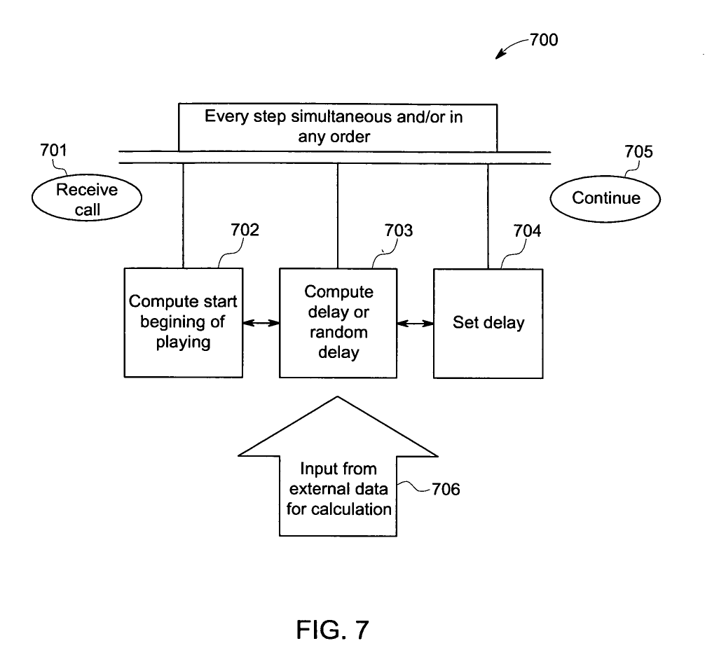

FIG. 7 is a flowchart of one possible embodiment of a process 700 for determining a randomized or customized delay to delay ringback tone playback. At block 701, a call is received. At block 702, a random delay or a set delay is computed internally, or with data and/or information from block 706. Next, at block 703, a delay is set and/or computed, which may or may not include a delay. At block 704, call progress may be totally or partially delayed by the set delay. The call continues in any manner at block 705. At block 706, external data or information (for example, but not limited to, size of the media file to be played, and transmission speed) are gathered and/or transmitted to block 703 or any other block.

The processes described herein may be a machine-readable medium having stored thereon data and instructions to cause a programmable processor to perform operations as described above. In other embodiments, the operations might be performed by specific hardware components that contain hardwired logic. Those operations might alternatively be performed by a subset of programmed computer components and custom hardware components.

Instructions for a programmable processor may be stored in a form that is directly executable by the processor (“object” or “executable” form), or the instructions may be stored in a human-readable text form called “source code” that can be automatically processed by a development tool commonly known as a “compiler” to produce executable code. Instructions may also be specified as a difference or “delta” from a predetermined version of a basic source code. The delta (also called a “patch”) can be used to prepare instructions to implement an embodiment of the invention, starting with a commonly-available source code package that does not contain an embodiment.

In the preceding description, numerous details were set forth. It will be apparent, however, to one skilled in the art, that the present invention may be practiced without these specific details. In some instances, well-known structures and devices are shown in block diagram form, rather than in detail, to avoid obscuring the present invention.

Some portions of the detailed descriptions were presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, compact disc read-only memory (“CD-ROM”), and magnetic-optical disks, read-only memories (“ROMs”), random access memories (“RAMs”), erasable, programmable read-only memories (“EPROMs”), electrically-erasable read-only memories (“EEPROMs”), Flash memories, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct more specialized apparatus to perform the required process steps. The required structure for a variety of these systems will appear from the description below. In addition, the present invention is not described with reference to any particular programming language. It will be appreciated that a variety of programming languages may be used to implement the teachings of the invention as described herein.

The embodiments of the present invention have been described largely by reference to specific examples illustrated in the figures and described above. However, those of skill in the art will appreciate that alternatives and modifications of the embodiments of this invention will become apparent to those skilled in the art without departing from the scope of this invention. Such variations and implementations are understood to be captured according to the following claims.

What is claimed:

1. A machine implemented method for setting a delay period before ringback tone playback, the method comprising:
receiving a call;
computing a randomized time period;
setting a post-dial delay to the randomized time period; and
delaying playback of a ringback tone for at least the randomized time period.

2. The method of claim 1, further comprising:
playing the ringback tone; and
connecting the call.

3. The method of claim 1, wherein the ringback tone is a personalized ringback tone.

4. The method of claim 1, wherein the ringback tone is a personalized ringback tone.

5. The method of claim 1, wherein the randomized time period is algorithmically generated.

6. The method of claim 1, wherein the post-dial delay is set to a predetermined time period instead of the randomized time period.

7. The method of claim 6, wherein the predetermined time period is determined by a predefined system parameter.

8. An apparatus for customizing a time period for delaying ringback tone playback, the apparatus comprising:
means for receiving a call;
means for determining a randomized delay;
and means for routing the call to a carrier.

9. The apparatus of claim 8, the means for routing the call to the carrier delays routing the call based on the randomized delay.

10. The apparatus of claim 8, further comprising:
means for determining a set delay.

11. The apparatus of claim 10, wherein the set delay is determined based on a system parameter.

12. The apparatus of claim 8, wherein the incoming call is received by direct inward dialing.

13. The apparatus of claim 8, wherein the call is received from one of a group comprising a VoIP trunk, ISDN trunk, SS7 trunk, or T1 trunk.

14. The apparatus of claim 8 further comprising:
means for converting the call to a VoIP signal.

15. The apparatus of claim 8 further comprising:
means for converting the call to a PSTN signal.

16. A computer-readable medium storing data and instructions to cause a programmable processor to perform operations comprising:
receiving a call;
computing a randomized time period;
setting a post-dial delay to at least the randomized time period; and
delaying playback of a ringback tone for at least the randomized time period.

17. The computer-readable medium of claim 16, including further operations comprising:
determining a set time period; and
delaying playback of the ringback tone for the set time period.

18. The computer-readable medium of claim 16, wherein the ringback tone is a personalized ringback tone.

19. The computer-readable medium of claim 16, including further operations comprising:
means for converting the call to a PSTN signal.

20. The computer-readable medium of claim 16, including further operations comprising:
playing the ringback tone; and
connecting the call.

21. The computer-readable medium of claim 16, wherein the randomized time period is a determined using a mathematical formula.

22. The computer-readable medium of claim 16, wherein the randomized time period is algorithmically generated.

23. The computer-readable medium of claim 16, wherein the post-dial delay is set to a predetermined time period instead of the randomized time period.

24. A machine implemented method for setting a delay period to increase the ringback tone playback, the method comprising:
receiving a call;
computing a randomized time period;
setting a post-dial delay to the randomized time period; and
delaying for at least the randomized time period the routing of the call.

25. The method of claim 24, further comprising:
playing the ringback tone; and
connecting the call.

26. The method of claim 24, wherein the ringback tone is a personalized ringback tone.

27. The method of claim 24, wherein the ringback tone is a personalized interactive ringback tone.

28. The method of claim 24, wherein the randomized time period is algorithmically generated.

29. The method of claim 24, wherein the post-dial delay is set to a predetermined time period instead of the randomized time period.

30. The method of claim 24, wherein the predetermined time period is determined by a predefined system parameter.

31. A ringback tone method comprising the following steps:
receiving a call;
computing a randomized time period;
setting a post-dial delay to at least the randomized time period; and
extending playback of a ringback tone for at least the randomized time period.

32. A ringback tone method comprising the following steps:
receiving a call;
computing a randomized time period;
setting a post-dial delay to at least the randomized time period;
delaying call routing for at least the randomized time period; and
starting the playing of the ringback tone during the randomized delay.

33. A ringback tone method comprising the following steps:
receiving a call;
computing a randomized time period;
setting a post-dial delay to at least the randomized time period;
delaying call routing for at least the randomized time period; and
starting the playing of the ringback tone before the randomized delay.

34. A ringback tone method comprising the following steps:
receiving a call;
computing a time period;
setting a post-dial delay to at least the computed time period; and
extending playback of a ringback tone for at least the randomized time period.

35. A ringback tone method comprising the following steps:
receiving a call;
computing a time period;
setting a post-dial delay to at least the computed time period;
delaying call routing for at least the randomized time period; and
starting the playing of the ringback tone playing during the randomized delay.

36. A ringback tone method comprising the following steps:
receiving a call;
computing a time period;
setting a post-dial delay to at least the computed time period;
delaying call routing for at least the randomized time period; and
starting the playing of the ringback tone before the randomized delay.

37. A method of gathering data during a computed delay period to be inserted during the ringback tone period, comprising the following steps:
gathering data from external sources;
computing the time period; and
delaying call progress for the computed time period.

38. A method of increasing consumer awareness by using randomized delays during message presentations, comprising the following steps:
computing of delay for interaction;
delay for computed length communication through multimedia; and
allowing for a communication to start or continue.

39. An apparatus for customizing a time period for delaying the ring tone signal at the called phone, said apparatus comprising:
a means for receiving a call;
a means for determining a randomized delay; and
a means for routing the call to a carrier.

40. The apparatus of claim 39, wherein the means for routing the call to the carrier delays routing the call based on the randomized delay.

41. The apparatus of claim 8, further comprising:
a means for determining a set delay.

42. The apparatus of claim 10, wherein the set delay is determined based on a system parameter.

43. An apparatus for customizing a time period for delaying a multimedia presentation at the called phone, said apparatus comprising:
a means for receiving a call;
a means for determining a randomized delay; and
a means for routing the call to a carrier.

44. The apparatus of claim 39 wherein the means for routing the call over VoIP delays routing the call based on the randomized delay.

45. The apparatus of claim 43, further comprising:
a means for determining a set delay.

46. The apparatus of claim 44, wherein the set delay is determined based on a system parameter.
